(19) United States
(12) Patent Application Publication
(10) Pub. No.: US 2015/0046558 A1
(43) Pub. Date: Feb. 12, 2015

(54) SYSTEM AND METHOD FOR CHOOSING LOWEST LATENCY PATH

(71) Applicant: Google Inc., Mountain View, CA (US)

(72) Inventor: Steven PADGETT, Sunnyvale, CA (US)

(73) Assignee: Google Inc., Mountain View, CA (US)

(21) Appl. No.: 14/011,233

(22) Filed: Aug. 27, 2013

Related U.S. Application Data
(60) Provisional application No. 61/790,241, filed on Mar. 15, 2013.

(51) Int. Cl. H04L 12/721

(52) U.S. Cl. CPC H04L 45/26
USPC 709/217

(57) ABSTRACT

A mechanism for reducing network latency by choosing the lowest latency network path, or a lower latency network path, from server to client. Instead of using a static, pre-built system for determining latency, the lowest latency path may be dynamically determined for each client connection at the time of connection establishment. Further, latency information may be periodically determined over time and averaged or otherwise utilized to account for changing network conditions.

### RELATED APPLICATION

This application is related to, and claims the benefit of, U.S. Provisional Patent Application No. 61/790,241, entitled “System and Method for Choosing Lowest Latency Path to a Peer”, filed Mar. 15, 2013, the contents of which are incorporated herein by reference in their entirety.

### BACKGROUND

Latency is the measure of time delay in a system. In order for a packet switched network to operate efficiently, it is important that the latency of packet flows be low. For example, a response to a client Hypertext Transfer Protocol (HTTP) request that is subject to increased latency will seem unreasonably slow to a client user. Latency in a network may be measured as either round trip latency or one-way latency. Round trip latency measures the one way latency from a source to a destination and adds to it the one-way latency for the return trip. It does not include the time spent at the destination for processing a packet. One-way latency measures only the time spent sending a packet to a destination that receives it. In order to properly measure one way latency, synchronized clocks are usually required which in turn requires the control of the source and destination by a single entity.

As a result of the control requirement for determining one-way latency, round-trip latency is more frequently used in accumulating network latency statistics as it can be measured from a single point. One well-known way to measure round-trip latency is for a source to “ping” a destination (sending a packet from a source to a destination where the packet is not processed but merely returned to the sender). In more complicated networks in which a packet is forwarded over many links, the calculated latency must also account for the time spent forwarding the packet over each link and transmission delay at each link except the final one.

Gateway queuing delays also may increase overall latency and should therefore also be considered when making a latency determination.

### SUMMARY

Embodiments of the present invention reduce latency by choosing the lowest latency path, or a lower latency path, from server to client. Instead of using a static, pre-built system for determining latency, the lowest latency path may be dynamically determined for each client connection at the time of connection establishment. Further, latency information may be periodically determined over time and averaged or otherwise utilized to account for changing network conditions when choosing a path for content delivery to the client.

In one embodiment, a computing-device implemented method for determining lowest path latency includes receiving at a server a request for content from a client device over an existing Transmission Control Protocol (TCP) connection. The method also includes transmitting near-identical packets to the client device over multiple network paths. The near-identical packets have identical TCP sequences and modified packet contents that include an instruction or attribute identifying an arrival network path upon which the near-identical packet was received. The server receives an identification from the client device of one of the network paths as the first network path which delivered one of the near-identical packets to the client device. The requested contents are transmitted over a selected one of the network paths based at least in part on the identification.

In another embodiment a computing-device implemented system for determining lowest network path latency includes a server that receives a request for content from a client device over an existing TCP connection. The system also includes a packet duplicator for generating and transmitting near-identical packets to the client device over multiple network paths. The near-identical packets have identical TCP sequences and modified packet contents that include an instruction or attribute identifying an arrival network path upon which the near-identical packet was received. The client device transmits to the server an identification of one of the network paths as being a first path which delivered one of the near-identical packets to the client device upon receipt of a first of the near-identical packets. The server transmits the requested contents over a selected one of the network paths based at least in part on the identification.

### BRIEF DESCRIPTION OF THE DRAWINGS

The accompanying drawings, which are incorporated in and constitute a part of this specification, illustrate one or more embodiments of the invention and, together with the description, help to explain the invention. In the drawings:

FIG. 1 depicts an exemplary sequence of steps followed by an embodiment to make a dynamic determination regarding network path latency;

FIG. 2 depicts an exemplary sequence of steps performed by a packet duplicator utilized by an embodiment of the present invention;

FIG. 3 depicts an exemplary network environment suitable for practicing an embodiment of the present invention;

FIG. 4 depicts an exemplary alternative network environment suitable for practicing an embodiment of the present invention; and

FIG. 5 depicts an exemplary sequence of steps followed by an embodiment to utilize stored information regarding network path latency.

### DETAILED DESCRIPTION

Embodiments of the present invention make dynamic latency determinations regarding desirable network paths for a client connection at the time of a client request for content. The latency determination may be used in isolation to determine how to route packets from a server to the client. Alternatively, the determination may be used together with previously performed latency determinations for the requesting client to provide additional information on changing network conditions. To make this dynamic latency determination, embodiments of the present invention take advantage of operational characteristics of the Transmission Control Protocol (TCP). More particularly, TCP stacks as currently implemented that receive duplicate packets with identical TCP sequence numbers treat the first received packet as the “right” one and discard any additional received packets with that sequence number. In an embodiment of the present invention, near-identical packets are sent at the same time (nearly simultaneously) to the client via different network paths. These near-identical packets have identical TCP sequence numbers but slightly different packet contents. Processing of the first received packet by the client results in the server being informed of the path that delivered its packet the fastest and the server then may deliver the requested content over this path or consider this new information together with stored information from previous latency determinations when making a network path routing determination.

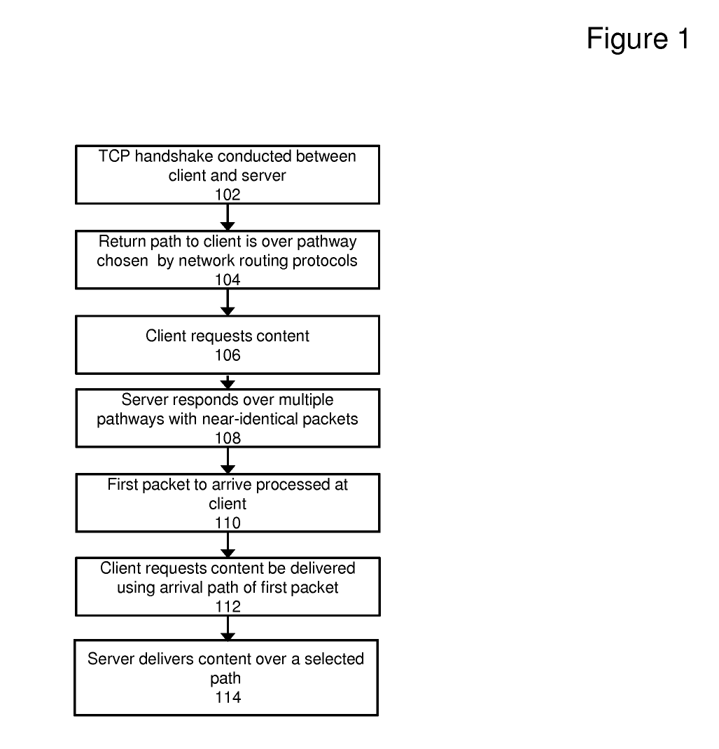

FIG. 1 depicts an exemplary sequence of steps followed by an embodiment to make a dynamic determination regarding network path latency. The sequence begins when the client connects to the server. A normal TCP handshake is conducted (SYN-SYN ACK-ACK) (step 102) and the client and server begin to communicate normally over the ‘natural’ network path (step 104). The “natural” network path in this case is the path chosen by the normal network routing protocols from among what is usually multiple available network paths from the server to the client. Subsequently the client issues a request, such as an HTTP “GET” request, for content controlled by the server (step 106). Based on the request, the server may decide that the content needs to be sent over the lowest latency available path. For example, the server may note that the client's last measurement had aged out or that the type of content requires low latency. The server sends back to the client nearly identical packets with identical TCP-sequence numbers and lengths but that have slightly different packet contents. These near-identical TCP-sequenced packets are sent to the client over different network paths. These packets are sent at approximately the same time within the same few milliseconds as described further below (step 108).

The determination of path latency in response to the client request for content may be made by means of an HTTP redirect that is sent to the client over the multiple network paths. A TCP frame in this HTTP redirect that is sent over the multiple network paths may be sent via a packet duplicator as discussed further below. This “special” TCP frame contains the same length, flags, and TCP sequence/ACK numbers. As a result, the frame looks to the network like a duplicated packet. However, the packets have different content and different TCP checksums. For example, the TCP content of the duplicated frames may look like the following when the frames are being sent over 4 paths:

Packet #1:

HTTP/1.1 302 Moved

Location: http://www.example.com/?path=path_{—}1

Packet #2:

HTTP/1.1 302 Moved

Location: http://www.example.com/?path=path_{—}2

Packet #3:

HTTP/1.1 302 Moved

Location: http://www.example.com/?path=path_{—}3

Packet #4:

HTTP/1.1 302 Moved

Location: http://www.example.com/?path=path_{—}4

The receipt of the first near-identical packet to arrive at the client device is processed (step 110). The processing of the packet triggers the client device to request that the content be delivered by the server using a specific path of the first packet, i.e.: the arrival path (step 112). For example, in the embodiment discussed above in which an HTTP re-direct is employed, the browser on the client device will issue a request for a new page (the use of the 302 HTTP/1.1 redirect indicates to a receiving browser that the original requested page has temporarily moved to the specified page). The server, upon receiving an URL with the ‘path’ attribute in this example, sends all data to the client over a selected path taking into account this new information regarding the lowest latency path (step 114). The mechanism by which the server gets the data to the client over that specific return path is outside the scope of this application but one example is that the server uses a tunneling protocol such as MPLS or GRE to direct the packets to an egress path to the client. An egress path is a path running from an egress point between the server's local network and the Internet or other network (such as a router), over the Internet or other network, and to the client device. This approach by embodiments of the present invention utilizes standard TCP functionality for processing “duplicate” packets for which no client-side TCP changes are required. Embodiments may also work transparently with client-side equipment like firewalls and transparent proxies as well as with many web browsers available today.

It should be appreciated that embodiments of the present invention are not limited to the use of HTTP redirects for determining a network path with a low latency. The use of the HTTP redirects in the near-identical packets introduces a slight delay as it requires a second browser request. To avoid this, in another embodiment, an HTTP cookie may be employed instead of the HTTP redirect. For example, in an embodiment, the trigger is set in an HTTP cookie, and the duplicated frame is part of the HTTP cookie. Use of such an HTTP cookie removes the delay attendant to the use of an HTTP redirect. Further, although the description herein is based on HTTP for ease of explanation, other protocols that offer a similar API are also within the scope of the present invention.

The above-described sending of near-identical packets over multiple network paths to a client by an embodiment of the present invention may make use of a packet duplicator. The packet duplicator may be an executable process running on a computing device separate from the device hosting the server or may be the same computing device hosting the server. A packet duplicator utilized by an embodiment may receive packets targeted for “duplication” by the server. The packet targeted for duplication is the specific packet to be sent, with the correct length, TCP sequence and acknowledgement numbers. The packet duplicator may duplicate the packets and modify the contents to instruct the client to tell the server which path is in use. The packet duplicator also may modify the TCP checksum. Other values may be left unaltered. The packet duplicator may also be responsible for making sure the packets are sent out by a designated egress point.

All of the duplicated near-identical packets being sent to a client may be sent from the packet duplicator immediately in sequence at almost the same time in order to remove the impact of latency. For example, on a 1G Ethernet segment where 128-byte “duplicate” packets (including Ethernet overhead) are sent back-to-back, there may be a 1.024 microsecond difference between the start of one near-identical packet and the start of the next near-identical packet. Ten frames sent in succession would therefore only have a 10 us difference between the start of the first frame and the start of the last frame. Since the latency differential between the network paths is typically observed to be on the order of 10-100 ms, the delay in the sequencing of the packets will not ordinarily be a concern as it is 1000x -10000x lower than the network path latency. In one embodiment, the packet duplicator may also be placed approximately equidistant (based on the network topology) from the egress points as compared to the server. With this configuration, the latency delays from the server to the client/user over the eventually chosen network path will be approximately the same as those latency delays that were experienced in sending the near-identical packets from the packet duplicator to the client/user over that path when the latency determination was originally made.

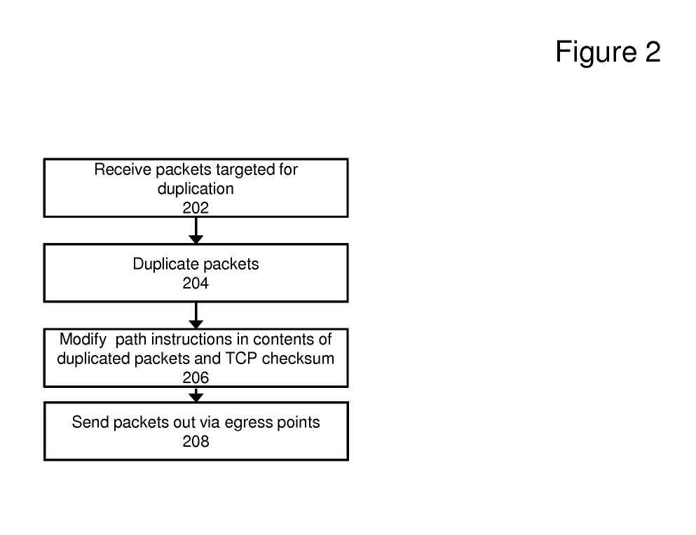

FIG. 2 depicts an exemplary sequence of steps performed by a packet duplicator utilized by an embodiment of the present invention. The sequence begins with the packet duplicator receiving packets for “duplication” from the server (step 202). The packet duplicator may duplicate the packets (step 204) and then modify the contents of the duplicated packets to include a path instruction or attribute identifying the path over which the packet is being sent and the TCP checksum (step 206). Alternatively, it will be appreciated that instead of first duplicating and then modifying the packets, the new packets may instead by modified as they are each constructed. Following the modification of the packet contents, the packets are forwarded to the client by the packet duplicator or another process through available egress points of the local network to which the server belongs (step 208).

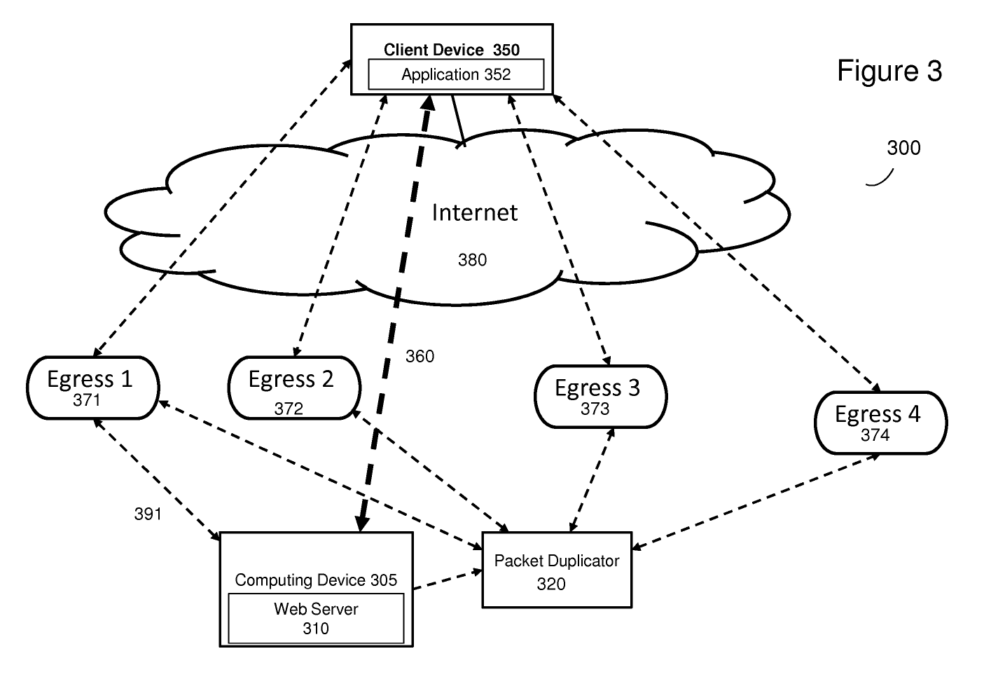

FIG. 3 depicts an exemplary network environment 300 suitable for practicing an embodiment of the present invention. As depicted there are four egress points 371, 372, 373 and 374 providing paths from a local network to the Internet 380 and the client device 350. It will be appreciated that the number of egress points 371-374 is illustrative. Also depicted is a computing device 305 hosting web server 310. Computing device 305 and client device 350 include one or more processors and one or more network interfaces. Web server 310 communicates with a duplicator process 320 (located on a separate computing device). In an embodiment of the present invention, an application 352 (such as a web browser) on the client device 350 may initiate a connection with the web server 310. A TCP connection 360 may be established between the computing device 305 and the client device 350 using a normal network path established by conventional network routing protocols. As discussed above, upon receiving a request for a particular type of content, a web server 310 in an embodiment of the present invention may decide to find the lowest latency path to the client device 350. The web server sends a specially crafted packet as described herein to the packet duplicator 320. The packet duplicator 320 then performs the “duplication” process discussed above in which only the path instruction in the contents and the TCP checksum is altered, and forwards the produced near-identical packets out through egress points 371-374 over the Internet 380 to the client device 350. The client device 350 receives one of the near-identical packets before the other near-identical packets. The client device 350 responds to the receipt of the packet contents by informing the server of the identity of the path on which the first arriving packet was transmitted. For example, the first arriving packet may arrive via a network path that includes egress point #1. Upon receiving the identity of the path from the client device, the web server 310 may send the originally requested content via a path 391 to egress point #1 (371) and on to the client device 350 . It should be noted that the re-routing of the client connection to a specific egress point is also something that can happen transparently to the TCP session itself, and does not necessarily require the existing TCP session to be torn down.

In certain situations all packets sent from the packet duplicator to the client may be lost. Accordingly, when this is the case, the web server's TCP stack will not receive an acknowledgement identifying any packet as the first delivered. Depending on the implementation, the server may then retry sending the packets, either by sending the packet to the duplicator again, or by just sending out the packet directly to the client.

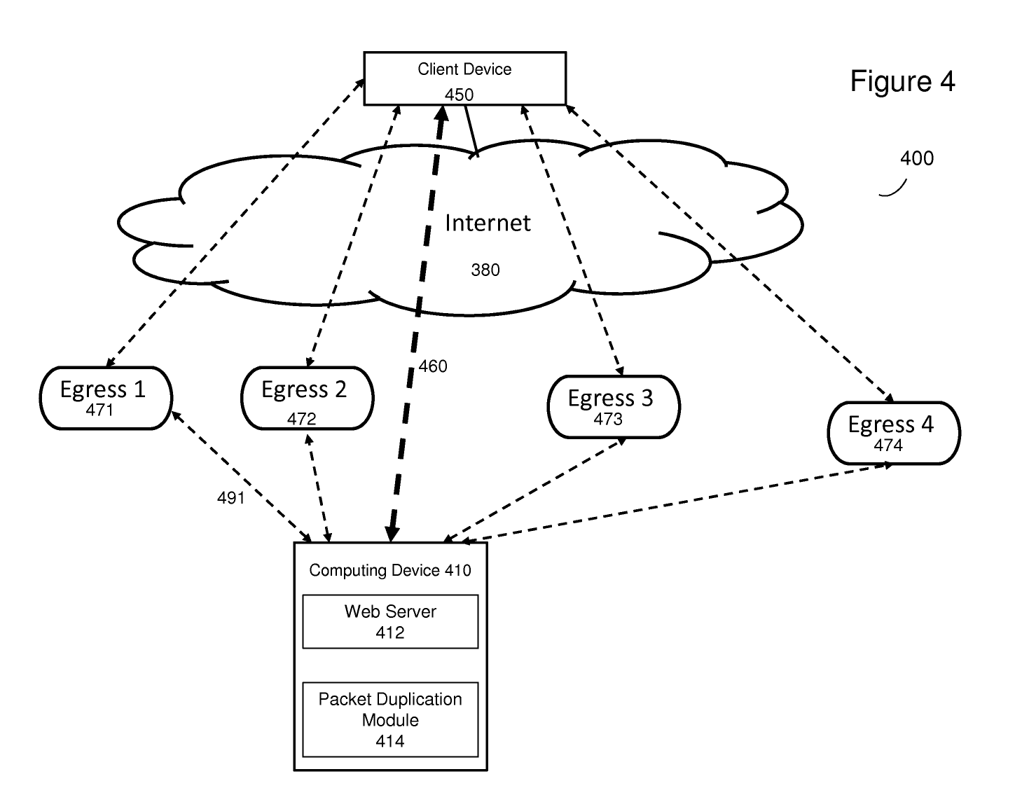

Although FIG. 3 depicts an environment in which the packet duplicator 320 and web server 310 are located on separate devices, other configurations are possible within the scope of the present invention. For example, FIG. 4 depicts an exemplary alternative network environment 400 suitable for practicing an embodiment of the present invention. In FIG. 4, computing device 410 hosts both web server 412 and packet duplication module 414. A TCP connection 460 is established between the client device 450 and the computing device 410 and an application on the client device 450 requests the delivery of content. In response to the request, the web server 412 prepares a specialized packet and forwards it to the packet duplication module 414. The packet duplication module 414 generates and sends the near-identical packets previously discussed to the client device 450 via egress points 471, 472, 473 and 474 and the Internet 380. The first arriving near-identical packet is processed on the client device and the web server 412 is informed of which path delivered the first near-identical packet. With this information, web server 412 determines over which network path to send the requested content to the client device 450. With this configuration in which the same computing device hosts both the web server 412 and the packet duplication module 414, the need to attempt to make sure that the packet duplicator and web server are equidistant from the egress points in the network topology is eliminated.

In another embodiment, a customized TCP stack may be employed instead by an application server to perform the rewrite and duplication functions of the packet duplicator that are discussed herein.

Rather than automatically selecting the path with the lowest latency to the client, in an embodiment the gathered latency information may be utilized in combination with previously gathered information and other criteria. For example, if some packets are lost in the network from the packet duplicator to the client, a non-lowest latency path may be selected. Failure recovery to address such packet loss may consist of the web server periodically checking to see what egress the client is preferring or switching over to the lowest latency path not currently being used. The latency responses may also be weighted to pick the lowest latency path out of the last X samples.

Network conditions change and the “lowest latency” path is not necessarily the one with the highest bandwidth. A network may experience temporary congestion or temporary network events may make one path have a high latency one time and a lower latency a few minutes later. While an embodiment of the present invention enables the dynamic location of the lowest latency path at the time of measurement, an embodiment also allows the latency measurement to be repeated for a client in order to verify that an originally selected lowest latency path continues to be the path currently having the lowest latency. In one embodiment, the paths selected for a client may be recorded and tracked over time. Based on adaptable criteria, the “best” path for a client/user may be selected even if the most recent measurement for that client/user has reported a lower latency path out a different egress.

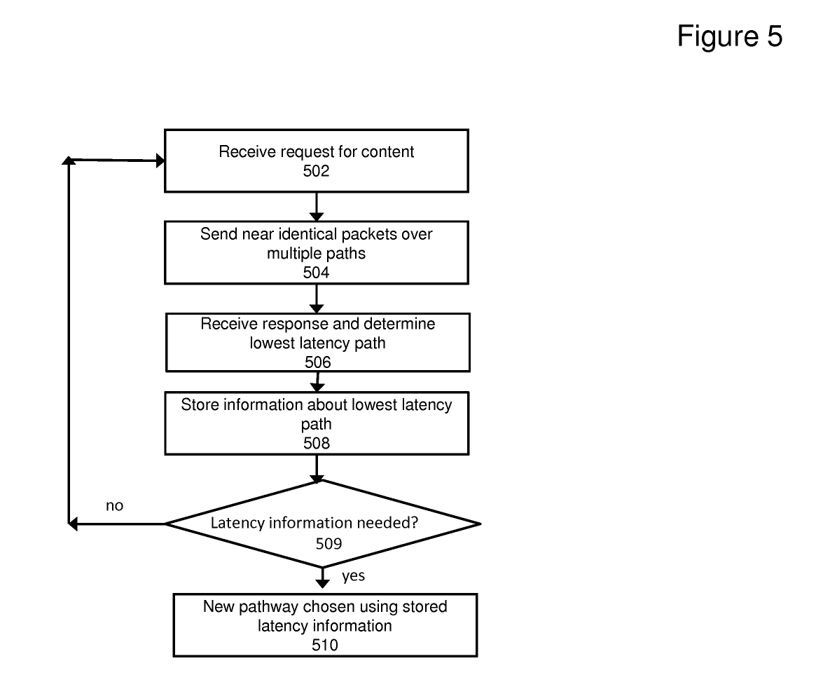

FIG. 5 depicts an exemplary sequence of steps followed by an embodiment to utilize stored information regarding path latency. The sequence begins with the web server receiving a request for content (step 502). The near-identical packets described above are sent to a client over multiple paths (step 504) and a response is received from the client and the lowest latency path determined (step 506). The information about the lowest latency path and alternatively the relative latency of all of the paths (which may be determined by repeating the path comparison multiple times with different sets of paths tested each time) is stored (step 508). A determination is made as to whether the latency information is needed based on network conditions (step 509). For example, packet loss over certain paths may cause the web server to re-evaluate the currently selected network path. If the latency information is not currently needed, the sequence iterates and continues to gather latency information based on pre-determined and other criteria. If however, a determination is made that the stored latency information is needed (step 509), it can be used instead of, or in addition to, currently determined latency information to choose a network path to the client (step 510).

Although embodiments of the present invention have been described herein as employing a server-client configuration, it should be appreciated that the present invention is not so limited. For example, embodiments may also be practiced in other configurations such as a peer-to-peer configuration rather than the above-described server-client arrangement.

Portions or all of the embodiments of the present invention may be provided as one or more computer-readable programs or code embodied on or in one or more non-transitory mediums. The mediums may be, but are not limited to, a hard disk, a compact disc, a digital versatile disc, ROM, PROM, EPROM, EEPROM, Flash memory, a RAM, or a magnetic tape. In general, the computer-readable programs or code may be implemented in any computing language. The computer-executable instructions may be stored on one or more non-transitory computer readable media.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

The foregoing description of example embodiments of the invention provides illustration and description, but is not intended to be exhaustive or to limit the invention to the precise form disclosed. Modifications and variations are possible in light of the above teachings or may be acquired from practice of the invention. For example, while a series of acts has been described, the order of the acts may be modified in other implementations consistent with the principles of the invention. Further, non-dependent acts may be performed in parallel.

We claim:

1. A computing-device implemented method for determining lowest network path latency, comprising:
receiving at a server a request for content from a client device over an existing TCP connection;
transmitting to the client device over a plurality of network paths near-identical packets, the near-identical packets having identical TCP sequences and modified packet contents that include an instruction or attribute identifying an arrival network path upon which the near-identical packet was received;
receiving at the server from the client device an identification of one of the plurality of network paths as being a first network path which delivered one of the near-identical packets to the client device; and
transmitting the requested contents over a selected one of the plurality of the network paths based at least in part on the identification.

2. The method of claim 1, further comprising:
storing latency information based on the identification.

3. The method of claim 1 wherein the requested contents are transmitted over the selected one of the plurality of network paths based on stored latency information and the identification.

4. The method of claim 1 wherein each of the near-identical packets have a different path instruction or attribute.

5. The method of claim 1, further comprising:
transmitting the non-identical packets to the client device using a packet duplicator.

6. The method of claim 1, further comprising:
transmitting the requested contents over a non-lowest latency network path in the plurality of network paths based on a detection of packet loss on an identified lowest latency path in the plurality of network paths.

7. The method of claim 1, further comprising:
periodically identifying one of the plurality of network paths as a lowest latency network path as a result of the transmission of the near-identical packets;
storing information related to the identifying for each transmission; and
transmitting the requested contents based on a determination of the identified lowest latency network path during a pre-determined time period using the stored information.

8. The method of claim 1 wherein the transmission of the requested content over the selected one of the plurality of network paths is switched to a different one of the plurality of network paths before the completion of the transmission of the requested content based on a subsequent receipt by the server of a second identification identifying the different one of the plurality of network paths as the first path to receive a near-identical packet following a second transmission of near-identical packets to the client device.

9. A non-transitory medium holding computing-device executable instructions for determining lowest path latency; the instructions when executed causing at least one computing device to:
receive at a server a request for content from a client device over an existing TCP connection;
transmit to the client device over a plurality of network paths near-identical packets, the near-identical packets having identical TCP sequences and modified packet contents that include an instruction or attribute identifying an arrival network path upon which the near-identical packet was received;
receive at the server from the client device an identification of one of the plurality of network paths as being a first network path which delivered one of the near-identical packets to the client device; and
transmit the requested contents over a selected one of the plurality of the network paths based at least in part on the identification.

10. The medium of claim 9 wherein the instructions when executed further cause the at least one computing device to:
store latency information based on the identification.

11. The medium of claim 9 wherein the requested contents are transmitted over the selected one of the plurality of network paths based on stored latency information and the identification.

12. The medium of claim 1 wherein each of the near-identical packets have a different path instruction or attribute.

13. The medium of claim 9 wherein the instructions when executed further cause the at least one computing device to:
transmit the non-identical packets to the client device using a packet duplicator.

14. The medium of claim 9 wherein the instructions when executed further cause the at least one computing device to:
transmit the requested contents over a non-lowest latency network path in the plurality of network paths based on a detection of packet loss on an identified lowest latency path in the plurality of network paths.

15. The medium of claim 9 wherein the instructions when executed further cause the at least one computing device to:
periodically identify one of the plurality of network paths as a lowest latency network path as a result of the transmission of the near-identical packets;
store information related to the identifying for each transmission; and
transmit the requested contents based on a determination of the identified lowest latency network path during a pre-determined time period using the stored information.

16. The medium of claim 9 wherein the transmission of the requested content over the selected one of the plurality of network paths is switched to a different one of the plurality of network paths before the completion of the transmission of the requested content based on a subsequent receipt by the server of a second identification identifying the different one of the plurality of network paths as the first path to receive a near-identical packet following a second transmission of near-identical packets to the client device.

17. A computing-device implemented system for determining lowest path latency, comprising:
a server, the server receiving a request for content from a client device over an existing TCP connection; and
a packet duplicator, the packet duplicator generating and transmitting to the client device over a plurality of network paths near-identical packets, the near-identical packets having identical TCP sequences and modified packet contents that include an instruction or attribute identifying an arrival network path upon which the near-identical packet was received, the client device transmitting to the server an identification of one of the plurality of network paths as being a first network path which delivered one of the near-identical packets to the client device upon receipt of a first of the near-identical packets,
wherein the server transmits the requested contents over a selected one of the plurality of the network paths based at least in part on the identification.

18. The system of claim 17 wherein the packet duplicator is located remotely from the server.

19. The system of claim 17 wherein the packet duplicator is located on a computing device hosting the server.

20. The system of claim 17 wherein the packet duplicator is located approximately equidistant as the server, based on network topology, from egress points to the plurality of network paths.
